(19) United States
(12) Patent Application Publication
(10) Pub. No.: US 2006/0073997 A1
(43) Pub. Date: Apr. 6, 2006

(54) Solutions for cleaning silicon semiconductors or silicon oxides

(75) Inventors: Oana Leonte, Hayward, CA (US); Robert Chebi, San Carlos, CA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Lam Research corporation, Fremont, CA (US)

(21) Appl. No.: 10/955,810

(22) Filed: Sep. 30, 2004

(51) Int. Cl. C23G 1/00; C11D 7/32

(52) U.S. Cl. 510/175; 134/2

(57) ABSTRACT

A solution for cleaning silicon semiconductors or silicon oxides, and methods for cleaning silicon semiconductors or silicon oxides using the solution, is disclosed. The solution includes hydrogen peroxide, ammonium hydroxide, an alkanolamine, and at least one of a tetraalkylammonium hydroxide, an alkanolamide, an amido-betaine, an α,α-dihydroxyphenol, a carboxylic acid, a phosphonic acid, a chelating agent or a surfactant. The weight ratio of ammonium hydroxide to peroxide to water is between about 1:1:5 and 1:1-4:50, the weight ratio of ammonium hydroxide to water is between 1:5 and 1:50, and the molar ratio of component A to ammonium hydroxide is between 1:10 and 1:5000 is disclosed. The solution can achieve the efficiency equivalent to that of the conventional RCA two-step cleaning solution within a shorter time by one step preserving the silicon and silicon oxide substrate integrity and effectively remove contaminants such as organics, particles and metals from the surfaces of silicon semiconductors and silicon oxides without using strong acids such as HCl and sulfuric acid.

### FIELD OF THE INVENTION

The present invention pertains to solutions for cleaning silicon semiconductors or silicon oxides. More specifically, the present invention provides solutions which can remove contaminants such as organics, particles and metals from the surfaces of silicon semiconductors and silicon oxides by one step.

### BACKGROUND OF THE INVENTION

The fabrication of devices beyond current scaling imposes alternative cleaning solutions to the traditional RCA cleaning to comply with the specs for particles, metals, organic and material (silicon and silicon oxide) loss, as published by ITRS surface preparation road map as requirements at 65 nm-technology node and beyond.

There are continuous efforts in the art of production of silicon semiconductors and micro-circuits to meet the requirements associated with the new leading edge devices. The cleaning steps are responsible for surface preparation and for controlling surface contamination, which is critical for device performance, reliability and cost. The increased fragility of the scaled and new device structures is limiting the aggressiveness of the cleaning processes that may be employed.

In 1970, RCA (Radio Corporation of America) developed an effective cleaning system for removing contaminants from surfaces of silicon semiconductors and silicon oxides. The system comprises two cleaning steps. An aqueous solution comprising hydrogen peroxide and ammonium hydroxide is used in the first step to remove organic contaminants. Since the solution may inevitably cause contamination with heavy metals such as Fe, Zn and Al which are trace metal contaminants in the solution, a solution containing HCl must be used in the second step to remove the metal contaminants. According to the RCA system, an effective cleaning operation comprises using a solution comprising 5:1:1 to 7:2:1 by volume of water/30% hydrogen peroxide/27% ammonium hydroxide in the first step for 10 to 20 minutes and using a solution comprising 6:1:1 to 8:2:1 by volume of water/30% hydrogen peroxide/37% HCl in the second step for 10 to 20 minutes. The Standard Clean-1, SC-1 (RCA-1) function is to remove the organic and particle contaminants, while the Standard Clean-2, SC-2 (RCA-2) function is to remove the metallic contaminants. In other words, RCA system must use strong acid chemicals such HCl, involves two steps and needs at least 20 minutes for cleaning.

Though RCA system can effectively remove heavy metal contaminants from the surfaces of wafers, particles contained in the acidic cleaning solution which comprises HCl will stick to and contaminate the surfaces. Further, RCA system involves two separate steps and this is an inconvenient operation. Persons in semiconductor device and silicon wafer in particle sries continuously search for new formulations to replace RCA system to provide an easier, more effective and more economical cleaning system.

Various approaches have been developed to replace the RCA system and most of them are directed to the cleaning solution of the second step. Japanese Patent KOKAI (Laid-Open) No. Sho 58-30135 discloses the use of an acidic aqueous solution containing HF, sulfuric acid and hydrogen peroxide. Japanese Patent KOKAI (Laid-Open) No. Hei 2-100320 discloses the use of a combination of a mixture of ammonium hydroxide and hydrogen peroxide in water and a mixture of HCl and hydrogen peroxide in water. A solution of strong acid and a very small amount of a compound containing fluorine is disclosed in Japanese Patent KOKAI (Laid-Open) No. Hei 4-234118. A solution containing 0.50% HF and 0.1 to 1% hydrogen peroxide is disclosed in “TRYBOROZIST” Vol. 37, No. 3, (1992) pp. 218-224 and the cleaning is conducted at room temperature. U.S. Pat. No. 5,560,857 discloses the use of an aqueous acidic solution containing 0.005% to 0.05% by weight HF and 0.3% to 20.0% by weight hydrogen peroxide and having a pH in the range from 1 to 5. In other words, most modifications on RCA system are directed to the substitution of the solution used in the second cleaning step.

However, as mentioned above, in addition to the shortcoming of particle contamination, RCA system further has the disadvantages of an inconvenient operation (involving two steps and requiring at least 20 minutes) and the use of strong acid chemicals. All the aforementioned known approaches cannot avoid these disadvantages. There is a necessity in the art of an effective cleaning system to simplify the RCA system, avoid the use of strong acid chemicals and meet the simple, effective and economical requirements.

### SUMMARY OF THE INVENTION

Cleaning solutions that can significantly reduce the cleaning time, simplify the cleaning procedures and avoid using strong acid chemicals are disclosed, as well as methods for using the compositions to clean silicon semiconductors or silicon oxides are disclosed. The silicon semiconductors are present, for example, in semiconductor integrated circuit devices. Integrated circuit elements with good key device electrical performance and charge to breakdown and breakdown field properties that are superior to those cleaned by RCA systems are also disclosed.

The solutions include hydrogen peroxide, ammonium hydroxide, an alkanolamine, and at least one of a component A selected from a tetraalkylammonium hydroxide, an alkanolamide or amido-betaine, an α,α-dihydroxyphenol, a carboxylic acid or a phosphonic acid or their salts, a chelating agent and a surfactant.

The weight ratio of ammonium hydroxide to peroxide to water is typically between about 1:1:5 and about 1:1:100, and the molar ratio of component A to ammonium hydroxide is between 1:10 and 1:1000. The alkanolamine is typically present in a ratio of about 0.1 to about 10 percent by weight, more typically in a range of about 0.1 to about 5 weight percent.

In one embodiment, the solution includes substantially no fluoride ions, and in this embodiment, the amount of surface etching of the substrate to be cleaned is minimized. In this embodiment, the amount of etching/material loss by etching is less than about two angstroms, whereas a comparable solution with the same components, to which fluoride is added, typically results in a material loss of more than twenty angstroms.

The methods of cleaning involve contacting the substrate to be cleaned with the solutions described herein for a sufficient amount of time to remove contaminants, such as organics, particles and metals from the surfaces of the substrates. In one embodiment, the methods further involve mechanical cleaning steps, although these often result in additional material loss.

The cleaning solutions and methods can replace the solutions used in the first and second steps of RCA system and can provide the efficiency of RCA cleaning system in a single step.

### BRIEF DESCRIPTION OF THE DRAWINGS

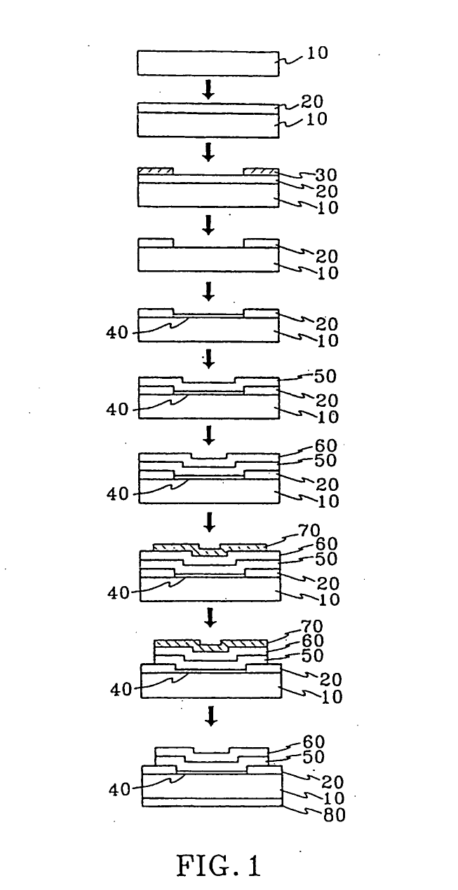

FIG. 1 shows a conventional procedure for preparing capacitor elements of integrated circuit, wherein:
10 represents a chip;
20 represents an oxide layer;
30 represents a photoresist layer;
40 represents a gate oxide layer;
50 represents a polysilicon layer;
60 represents an aluminum layer;
70 represents a photoresist layer; and
80 represents an aluminum layer.

### DETAILED DESCRIPTION OF THE INVENTION

The present invention provides solutions which can provide the cleaning efficiency equivalent to that provided by RCA system in one step and can be used for cleaning the surfaces of silicon semiconductors and silicon oxides, and methods for cleaning these surfaces using the solutions. Specifically, the present invention provides solutions for removing contaminants such as organics, particles and metals from the surfaces of silicon semiconductors and silicon oxides at controlled etch rates of silicon and silicon oxide with the preservation of substrate integrity.

I. Cleaning Solutions

The solutions of the present invention include hydrogen peroxide, ammonium hydroxide, alkanolamines, and at least one component A selected from the group consisting of tetraalkylammonium hydroxides, alkanolamides, α,α-dihydroxyphenols, carboxylic acids, phosphonic acids, chelating agents and surfactants.

As used herein, the alkyl groups in the various components described herein generally include between 1 and 6 carbon atoms. The alkyl groups can be straight chained, branched or cyclic having generally 1-6 carbon atoms, specifically, for example, a methyl group, an ethyl group, a n-propyl group, an isopropyl group, a cyclopropyl group, a n-butyl group, an isobutyl group, a sec-butyl group, a tert-butyl group, a n-pentyl group, an isopentyl group, a tert-pentyl group, a 1-methylpentyl group, a cyclopentyl group, a n-hexyl group, an isohexyl group and a cyclohexyl group.

Alkanolamines

Examples of suitable alkanolamines include, but are not limited to, monoethanolamine, diethanolamine, triethanolamine, 2-methylaminoethanol, 2-ethylaminoethanol, N-methyldiethanolamine, dimethylaminoethanol, 2-(2-aminoethoxy)ethanol, 1-amino-2-propanol, monopropanolamine, and dibutanolamine, 4-(2-hydroxyethyl)morpholine, and 4-(3-aminopropyl)morpholine.

Tetraalkylammonium Hydroxides

Examples of suitable tetraalkylammonium hydroxides that can be used in the cleaning solutions described herein include, but are not limited to, tetraalkylammonium hydroxides having methyl, ethyl, propyl, butyl, and hydroxyethyl groups, and combinations thereof (e.g., tetramethylammonium hydroxide (hereinafter referred to as TMAH), tetraethylammonium hydroxide, trimethyl hydroxyethylammonium hydroxide, methyl tri (hydroxyethyl) ammonium hydroxide, tetra (hydroxyethyl) ammonium hydroxide, benzyl trimethylammonium hydroxide and the like).

Alkanolamides/Amido-Betaines

An alkanolamide is a compound that includes a alkyl hydroxy group and an amide group. An amido-betaine is a compound that includes an amide group and a betaine group. Examples of suitable alkanolamides are those derived from fatty acids. A preferred alkanolamide is cocodiethanolamide. Other suitable alkanolamides include lauric/myristic monoethanolamide, coconut monoethanolamide, lauric diethanolamide, unmodified coconut diethanolamide, and other modified fatty alkanolamides or amido-betaines as also cocoamidopropyl betaine.

Dihydroxyphenols

Dihydroxyphenols are phenols that include at least two hydroxy groups, and optionally include other functional groups, such as alkyl, halo, carboxylic acid, amine, and the like. Examples of suitable dihydroxyphenols include, but are not limited to, o-dihydroxyphenol, m-dihydroxyphenol, p-dihydroxyphenol, gallic acid, catechol, alkyl resorcinols such as 2-methyl resorcinol and 5-methyl resorcinol, and 3,4-dihydroxyphenylalanine.

Carboxylic Acids/Chelating Agents/Surfactants

A chelate, sometimes referred to as a sequestrant, a complex ion, and/or a coordination compound, is an organic compound that combines with a metal ion to form a complex in which the donor atoms are connected to each other as well as to the metal. Ethylenediaminetetraacetic acid (EDTA) is one of the best known examples of a chelating agent. EDTA has two amine donor groups and four carboxyl donor groups. It can thus supply the complete requirements for the coordination sphere of many metals with a single molecule where it might take three molecules of ethylenediamine to meet the same-requirements. A chelating agent that supplies two donor electrons to the metal is said to be bidentate. Similarly ter-, quadri, quinqui-, and sexadentate donors, bind the metal in 3, 4, 5, and 6 positions, respectively. Hence, EDTA is sexadentate and ethylenediamine is bidentate, for example.

Generally, chelating compounds that are useful in the cleaning solutions described herein include, but are not limited to, sugars, amino acids, organic diacids, diamines, alpha ketoacids, alphahydroxyacids, aminodiacids, amino triacids, amino tetraacids, and organic polyacids and their sodium, potassium, and ammonium salts. Specific examples of these chelating compounds include, but are not limited to the sugars, acids and salts of maleic acid, malonic acid, tartaric acid, citric acid, ascorbic acid, glycine, lactic acid, malic acid, succinic acid, oxalic acid, dextrose, ethylenediaminetetraacetic acid (EDTA), tris(hydroxymethyl)aminomethane, lactose, mannitol, glutaric acid, malic acid, succinic acid, glycerol, humic acid, fulvic acid, sorbic acid, sorbose, ethylene diamine, 1,2 diaminocyclohexane, trimethylenediamine, tetramethylenediamine, 1,2 diaminopropane, diethylenetriamine, triethylenetetramine, triaminodiethylamine, N-hydroxyethylethylenediamine, sodium polyphosphate, potassium polyphosphate, ammonium polyphosphate, sodium hexametaphosphate and mixtures thereof.

In one embodiment, the chelating agent is at least one compound selected from the group consisting of ethylenediaminetetraacetic acid, oxalic acid, ammonium oxalate, 1-hydroxyethylidenediphosphonic acid, citric acid, ammonium citrate, catechol, ethylenediaminediorthohydroxyphenylacetic acid [EDDHA], 8-quinolinol, and tropolone.

The chelating agent used in the present cleaning solutions can be 100% of any particular chelator, or a combination of chelator in any ratio. A combination or mixture of chelating compounds may dissolve faster than a single compound. However, 100% oxalic acid, 100% citric acid, 100% EDTA, and combinations of these three can be preferred.

Examples of carboxylic acids and carboxylic acid-containing chelating agents that can be used in the cleaning solutions include, but are not limited to, fatty acid and alkyl ether carboxylic acid and their corresponding salts and esters (for example, C₁₋₂₀ esters). Carboxylic acids with between 1 and 20 carbon atoms can also be used, as can compounds with two or more carboxylic acid groups. Examples of carboxylic acids, and chelating agents including carboxylic acid groups, include malonic acid, succinic acid, stearic acid, maleic acid, lactic acid, glycolic acid, hydroxycaboxylic acids such as citric acid and tartaric acid, and aminopolycarboxylic acids such as ethylenediamine tetraacetate (EDTA), trans-1,2-diaminocyclohexane-N,N,N′-,N′-tetraacetate (CyDTA), diaminopropanol tetraacetate (DPTA-OH), ethylenediamine diacetate (EDDA), ethylenediamine dipropionic acid dichloride (EDDP), hydroxyethylethylenediamine triacetate (EDTA-OH), glycoletherdiamine tetraacetate (GEDTA), 1,6-hexamethylenediamine-N,N,N′,-N′-tetraacetate (HDTA) and diaminopropane tetraacetate (Methyl-EDTA).

Other suitable chelating agents include quinaldines such as quinaldic acid, aromatic diamines such as diaminobenzene and diaminonaphthalene, ureas such as urea and uric acid, thioureas such as thiourea and thiosemicarbazide.

Polyamines such as diethylenetriamine, dipropylenetriamine and triethylenetetraamine, aminopolycarboxylic acids such as triethylenetetramine hexaacetate (TTHA) and diethylenetriamine-N,N,N′,N″,-N″-pentaacetate (DTPA), can also be used.

Examples of carboxylic acids derivatives functioning as surfactants are PEG-150 stearate, glycolic acid ethoxylate ethers, e.g. laureth carboxylic acids, sorbitan laureate sulfate, PEG-80 sorbitan laureate, ammonium lauryl sulfate, others.

Phosphonic Acids/Chelating Agents

Examples of chelating compounds having phosphonic acid groups include, for example, ethylenediaminetetramethylenephosphonic acid, ethylenediaminedimethylenephosphonic acid, nitrilotrismethylenephosphonic acid, 1-hydroxyethylidenediphosphonic acid, aminopolyphosphonic acids such as ethylenediaminetetrakis (methylenephosphonic acid) (EDTPO), ethylenediamine-N,N′-bis (methylenephosphonic acid) (EDDPO) isopropyldiaminetetrakis (methylenephosphonic acid) and aminopolyphosphonic acids such as diethylenetriamine-N,N,N′,N″,N″-penta (methylenephosphonic acid). Among them, 1-hydroxyethylidenediphosphonic acid is preferred.

Weight/Mole Ratios of Individual Components

The weight ratio of ammonium hydroxide to peroxide to water is typically between about 1:1:5 and about 1:1-4:100, and the molar ratio of component A to ammonium hydroxide is between 1:10 and 1:1000. The amount of alkanolamine is typically between about 0.1 and about 10 weight percent, more typically between about 0.1 and 5 weight percent.

The cleaning solutions described herein include specific amounts of hydrogen peroxide, ammonium hydroxide and at least one component A, wherein the weight ratio of hydrogen peroxide to water is between 1:5 and 1:100, preferably between 1:10 and 1:40 and most preferably between 1:20 and 1:40; the weight ratio of ammonium hydroxide to water is between 1:5 and 1:100; preferably between 1:10 and 1:50 and most preferably between 1:20 and 1:40; and the molar ratio of component A to ammonium hydroxide is between 1:10 and 1:5000, preferably between 1:10 and 1:1000, most preferably between 1:50 and 1:500, especially between 1:100 and 1:500.

The cleaning solutions described herein can replace the two-step RCA system and can provide the efficiency of RCA system within a shorter time by one step and effectively remove the contaminants such as organics, particles and metals from surfaces of silicon semiconductors and silicon oxides.

In one embodiment, the cleaning solution is used prior to the formation of gate oxide on surfaces of silicon semiconductors or silicon oxides to remove contaminants including organics, particles and metals from the surfaces. The cleaning solution can achieve cleaning efficiency in one step and within a time shorter than that of two-step RCA system without using strong acids such as HCl and sulfuric acid.

The cleaning solutions are generally in the form of aqueous solutions, and can be prepared by adding and dissolving the above-listed components in the above-described weight/mole ratios in water.

The components can be separately dissolved in water and then mixed to form the cleaning solutions, or solid or liquid compounds can be added directly to water, followed by dissolving and stirring, or the like. The cleaning solutions are preferably filtered before use, and it is also preferred that the water used to prepare the cleaning solutions is purified by distillation, ion exchange or the like, and is ideally in the form of “ultrapure water” as this term is known in the art.

The cleaning solutions are preferably weakly acidic to alkaline, generally with a pH in the range of 4-13, preferably between about pH 5 and 12, more preferably, between about 6 and 9. In such pH range, silicon dioxide interlayer dielectrics have less risk of being etched. Further, the cleaning effect for particles and copper oxide is improved due to enhanced electric repulsion between the semiconductor surface and the particles.

II. Cleaning Methods

The semiconductors can be cleaned using any conventional method of cleaning semiconductors using cleaning solutions, including dipping and spraying techniques.

In one embodiment, a mechanical cleaning step is also performed, before, during or after the chemical cleaning step. Examples of suitable mechanical cleaning steps for these materials are described, for example, in U.S. Pat. No. 6,780,773, the contents of which are hereby incorporated by reference.

Physical cleaning includes, for example, brush-scrub cleaning to clean the surface of a semiconductor with a high-speed rotation brush made of polyvinylalcohol, and megasonic cleaning using high frequency.

The physical cleaning can be done in various ways: after providing a cleaning solution on the surface of a semiconductor by dipping the semiconductor in the cleaning solution and then taking it out of the cleaning solution; while a semiconductor is dipped in a cleaning solution; or as the surface of the semiconductor is sprayed or showered in the cleaning agent.

FIG. 1 shows a conventional procedure for preparing capacitor elements of integrated circuits. Chip 10 is cleaned by using a cleaning solution and oxide layer 20 is formed above chip 10 by wet oxidation. A photoresist layer is then formed above layer 20 and a mask is used to expose the desired region so as to obtain photoresist layer 30. Thereafter, the uncovered oxide region is removed by an etching agent and photoresist layer 30 is removed. Chip 10 which is covered by oxide layer 20 is cleaned by a cleaning solution and then gate oxide layer 40 is formed by dry oxidation. Polysilicon layer 50 is formed on chip 10 and optional dopants can be used to dope polysilicon layer 50 into the desired type. Aluminum layer 60 is formed on polysilicon layer 50. A photoresist layer is formed on aluminum layer 60 and a mask is used to expose the desired region so as to obtain photoresist layer 70. An etching agent is used to remove the regions of aluminum and polysilicon layers uncovered by photoresist layer and any possible oxides formed on the back side of chip 10. Aluminum layer 80 is formed on the back side of chip 10 and photoresist layer 70 is moved. Chip 10 is put in an annealing furnace for annealing to obtain the desired integrated circuit element.

Assessment of Cleaning Efficiency

The semiconductor thickness can be measured (before and after cleaning, if desired) using spectroscopic ellipsometry. This can be used, for example, to provide a measure of how much wafer thickness was lost as a result of cleaning. The presence of residual metal or organic contaminants can be measured by various mass spectrometry techniques as are known in the art.

The electrical properties of cleaned semiconductors can be tested by determining the statistical distributions of charge to breakdown and breakdown field of the semiconductors. The charge to breakdown and breakdown field can be tested, for example, at a current density of 50 mA/cm². The efficiency of the cleaning solution described herein can be evaluated by comparing the electrical properties of cleaned semiconductors with those provided by an RCA system. In

The foregoing is illustrative of the present invention and is not to be construed as limiting thereof. The invention is defined by the following claims, with equivalents of the claims to be included therein.

1. An aqueous solution for cleaning surfaces of silicon semiconductors or silicon oxides comprising hydrogen peroxide, ammonium hydroxide, an alkanolamine, and at least one component A selected from the group consisting of a tetraalkylammonium hydroxide, an alkanolamide, an amido-betaine, an α,α-dihydroxyphenol, a carboxylic acid, a phosphonic acid, a chelating agent and a surfactant, where the alkyl groups in the above groups include between 1 and 6 carbon atoms,
wherein the weight ratio of ammonium hydroxide to peroxide to water is between about 1:1:5 and about 1:14:100, and the molar ratio of component A to ammonium hydroxide is between 1:10 and 1:1000, and the amount of alkanolamine is between 0.1 and 10 weight percent of the solution.

2. The solution of claim 1, wherein the molar ratio of component A to ammonium hydroxide is between 1:100 and 1:500

3. The solution of claim 1, wherein the weight ratio of ammonium hydroxide to water is between 1:10 and 1:40.

4. The solution of claim 1, wherein the weight ratio of hydrogen peroxide to water is between 1:10 and 1:40.

5. The solution of claim 1, wherein the alkanolamine is selected from the group consisting of monoethanolamine, methyldiethanolamine, diethanolamine, triethanolamine, 2-methylaminoethanol, 2-ethylaminoethanol, N-methyldiethanolamine, dimethylaminoethanol, 2-(2-aminoethoxy)ethanol, 1-amino-2-propanol, monopropanolamine, N,N-dimethyl-2-(2-aminoethoxy)ethanol, and dibutanolamine.

6. The solution of claim 1, wherein the tetraalkylammonium hydroxide is selected from the group consisting of tetramethylammonium hydroxide, tetraethylammonium hydroxide, tetrabutylammonium hydroxide, trimethyl hydroxyethylammonium hydroxide, methyl tri (hydroxyethyl) ammonium hydroxide, tetra (hydroxyethyl) ammonium hydroxide, and benzyl trimethylammonium hydroxide.

7. The solution of claim 1, wherein the alkanolamide or amido-betaine is selected from the group consisting of cocodiethanolamide, lauric/myristic monoethanolamide, coconut monoethanolamide, lauric diethanolamide, cocoamidopropyl betaine and modified or unmodified coconut diethanolamide.

8. The solution of claim 1, wherein the α,α-dihydroxyphenol is selected from the group consisting of o-dihydroxyphenol, m-dihydroxyphenol, p-dihydroxyphenol, gallic acid, catechol, alkyl resorcinols, and 3,4-dihydroxyphenylalanine.

9. The solution of claim 1, wherein the carboxylic acid is selected from the group consisting of fatty acids, C₁₋₂₀ alkyl ether carboxylic acids, C₁₋₂₀ carboxylic acids with one or two carboxylic acid groups, and salts or esters thereof.

10. The solution of claim 1, wherein the chelating agent is selected from the group consisting of ethylenediamine tetraacetate (EDTA), trans-1,2-diaminocyclohexane-N,N,N′-,N′-tetraacetate (CyDTA), diaminopropanol tetraacetate (DPTA-OH), ethylenediamine diacetate (EDDA), ethylenediamine dipropionic acid dichloride (EDDP), hydroxyethylethylenediamine triacetate (EDTA-OH), glycoletherdiamine tetraacetate (GEDTA), 1,6-hexamethylenediamine-N,N,N′,-N′-tetraacetate (HDTA), diaminopropane tetraacetate (methyl-EDTA), ascorbic acid, oxalic acid, ammonium oxalate, 1-hydroxyethylidenediphosphonic acid, citric acid, ammonium citrate, catechol, ethylenediaminediorthohydroxyphenylacetic acid [EDDHA], 8-quinolinol, and tropolone.

11. A method for cleaning surfaces of silicon semiconductors or silicon oxides in a single step comprising applying a solution according to claim 1 to the surfaces of the silicon semiconductors or silicon oxides.

12. The method of claim 11, further comprising a mechanical cleaning step.
